(19) United States
(12) Patent Application Publication
(10) Pub. No.: US 2020/0311413 A1
(43) Pub. Date: Oct. 1, 2020

(54) DOCUMENT FORM IDENTIFICATION

(71) Applicant: Konica Minolta Laboratory U.S.A., Inc., San Mateo, CA (US)

(72) Inventors: Yongmian ZHANG, Union City, CA (US); Shubham AGARWAL, Belmont, CA (US)

(21) Appl. No.: 16/368,304

(22) Filed: Mar. 28, 2019

(51) Int. Cl. G06K 9/00; G06K 9/62

(52) U.S. Cl. CPC G06K 9/00483; G06K 9/00449; G06K 9/6267; G06K 9/6212; G06K 9/00469

(57) ABSTRACT

Image processing is performed on an input image generated from scanning a filled-in document form. The input image is evaluated against a blank version of various document forms in order to identify the form type of the filled-in document form. The evaluation results in identifying one of the blank document forms as a match to the filled-in document form. Each document form has a set of keywords. The evaluation uses a vector of keyword matches in the filled-in document form. Once a blank document form is identified to be match, the filled-in document form may be categorized according to that document form and/or data extracted from the filled-in document may be stored in association with keywords of that document form.

### FIELD

This disclosure relates generally to image processing and, more particularly, to processing to match an input image to a document form.

### BACKGROUND

Document forms are used in business, government, education, and other fields. For example, a document form can be an invoice that lists products or services with corresponding information, such as date and quantity. When filled in with information, the invoice may be scanned to obtain an electronic image file, such as a pdf file, that can be archived in a database for record keeping purposes. Information in the document form is often extracted and encoded in the electronic image file. For example, character recognition may be performed by a computer to encode an electronic image file of an invoice with product names that appear on the invoice. Thus, a search operation may be performed to find all invoices that contain a particular product name. However, more complex operations may be desired. For example, an operation may be needed to convert the electronic image file to a spreadsheet file or other editable format. An operation may be needed to aggregate information from multiple document forms for data analysis. For example, it may desired to aggregate data from all invoices during one year to identify seasonal trends from analysis of sale dates and quantities for various products. To enable complex operations such as these or others, a filled-in document form needs to be identified as having a particular form (e.g., particular arrangement of information) so that various pieces of information, such as sale dates and quantities, may be recognized appropriately. Form identification is complicated by the fact that many document forms are electronically generated so as to be expandable. That is, the same document form may look different depending on how it is filled out. For example, FIGS. 1A and 1B show the same type of a document form. In FIG. 1A, the packing list has three product rows since three products are listed. In FIG. 1B, the packing list has one product row since only one product is listed. It is also possible for such forms to adjust horizontally in size depending on the amount of text in the cells. Form identification becomes more complicated when different types of document forms must be processed. It is contemplated that a business or other organization may issue and/or receive many different types of document forms from which data is to be extracted and aggregated. For example, a business may receive packing lists from various retailers, where the packing lists have header text that differ.

Accordingly, there is a need for a method and system for identify document forms under a variety of processing conditions, such as processing expandable document forms and processing multiple types of document forms.

### SUMMARY

Briefly and in general terms, the present invention is directed to an image processing method and system for form identification.

In aspects of the invention, an image processing method comprises performing a plurality of evaluations on an input image having text, the evaluations performed to match the input image to a document form that is identified out of a plurality of document forms, each one of the evaluations performed using a candidate form among the plurality of document forms, the candidate form for each evaluation differing from those of the other evaluations. Each evaluation comprises associating one or more words in the text of the input image to one or more keywords in a reference image of the candidate form, the associating performed to identify keyword matches in the input image. Each evaluation comprises determining a form matching score for the candidate form, the form matching score determined from keyword match vertices representing locations of keyword matches in the input image. The image processing method comprises identifying a first document form as being a match to the input image, the first document form being one of the candidate forms in the plurality of evaluations, the identifying performed according to the form matching score that was determined for the first document form.

In aspects of the invention, an image processing system comprises a processor and a memory in communication with the processor, the memory storing instructions, wherein the processor is configured to perform a process according to the stored instructions. The process comprises performing a plurality of evaluations on an input image having text, the evaluations performed to match the input image to a document form that is identified out of a plurality of document forms, each one of the evaluations performed using a candidate form among the plurality of document forms, the candidate form for each evaluation differing from those of the other evaluations. Each evaluation comprises associating one or more words in the text of the input image to one or more keywords in a reference image of the candidate form, the associating performed to identify keyword matches in the input image. Each evaluation comprises determining a form matching score for the candidate form, the form matching score determined from keyword match vertices representing locations of keyword matches in the input image. The process comprises identifying a first document form as being a match to the input image, the first document form being one of the candidate forms in the plurality of evaluations, the identifying performed according to the form matching score that was determined for the first document form.

The features and advantages of the invention will be more readily understood from the following detailed description which should be read in conjunction with the accompanying drawings.

### BRIEF DESCRIPTION OF THE DRAWINGS

FIGS. 1A and 1B show filled-in document forms of the same type but differ in the number of rows.

FIG. 2 shows an example process for processing an input image to identify a document form that matches the input image.

FIG. 3 shows a reference image of an example of a blank document form.

FIG. 4 shows a reference image of another example of a blank document form.

FIGS. 5A and 5B show a keyword cropped from the reference image of FIG. 4.

FIG. 5C is an enlarged view of a portion of the keyword of FIG. 5A.

FIG. 6A is a diagram showing an example histogram template.

FIG. 6B is a linear version of the histogram template of FIG. 6A.

FIG. 6C is a diagram showing an example histogram for point Pi of FIG. 5C.

FIG. 6D is a linear version of the histogram of FIG. 6C.

FIG. 7A is an enlarged view of a portion of the keyword of FIG. 5B, showing a local region centered on point Pi.

FIG. 7B is a linear version of a histogram for point Pi of FIG. 7A, showing the distribution of points within the local region.

FIG. 8 is an example input image generated by scanning a filled-in document form.

FIG. 9 is a flow diagram shown an example analysis performed on an input image for identifying a document form that matches the input image.

FIG. 10 is a diagram showing how a keyword of a document form and a target word of an input image are associated with one another using histograms of points within local regions.

FIG. 11A shows a histogram for a first point on the keyword and a histogram of first point on the target word, and showing how they result in tally number H(1,1).

FIG. 11B shows the histogram for the first point on the keyword and a histogram of a second point on the target word, and showing how they result in tally number H(1,2).

FIG. 12 is an example reference image of a blank document form, annotated with numerical location labels associated with keywords.

FIG. 13 is an example input image of a filled-in document form, annotated with numerical location labels associated with keyword matches and showing resulting vectors.

FIGS. 14A, 14B, and 14C are example bipartite graphs of the vectors of FIG. 13.

FIG. 15 is a flow diagram showing an example analysis performed on an input image for identifying a document form that matches the input image.

FIG. 16A is an example input image.

FIG. 16B is an example reference image of a candidate form, shown with a bipartite graph formed by evaluating the reference image with the input image of FIG. 16A.

FIG. 16C is an example reference image of a candidate form, shown with a bipartite graph formed by evaluating the reference image with the input image of FIG. 16A.

FIG. 17 is a schematic diagram showing an example system for image processing, the system comprising an apparatus and a database connected to the apparatus via a network.

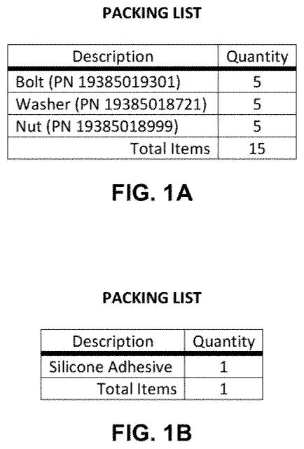

### DETAILED DESCRIPTION

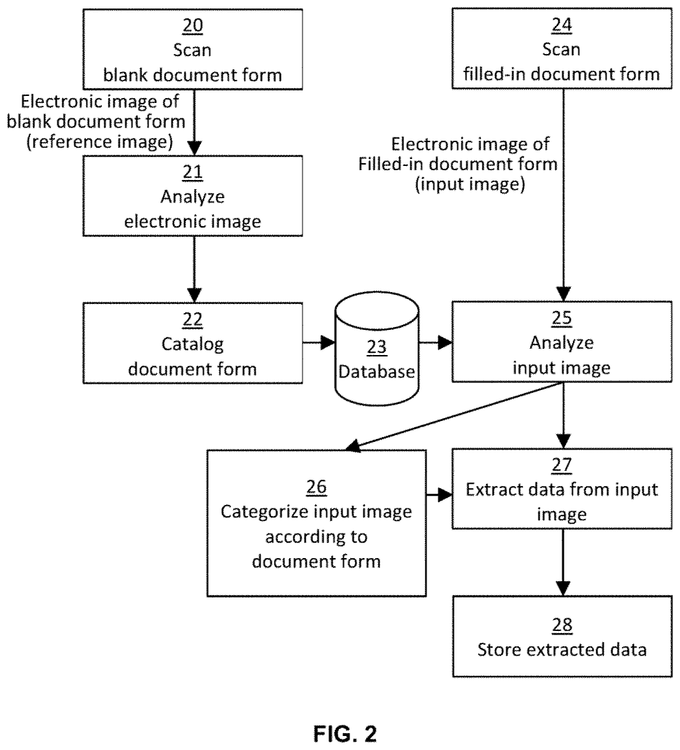

Referring now in more detail to the drawings for purposes of illustrating non-limiting examples, wherein like reference numerals designate corresponding or like elements among the several views, there is shown in FIG. 2 an example image processing method. One or more types of document forms are scanned 20 and analyzed 21, and then cataloged 22 in database 23. Scanning 20 includes feeding a blank version of the document form to a scanner to obtain an electronic image (e.g., jpg, bmp, pdf or other format), which is analyzed. The electronic image is referred to as a reference image. Analyzing 21 reference image includes identifying keywords in the document form and obtaining histograms associated with the keywords. Selection of keywords may be performed with the aid of a human user and/or a computer executing a character recognition algorithm. Cataloging 22 includes storing in database 23 the histograms in association with keywords, and storing the keywords in association with the document form.

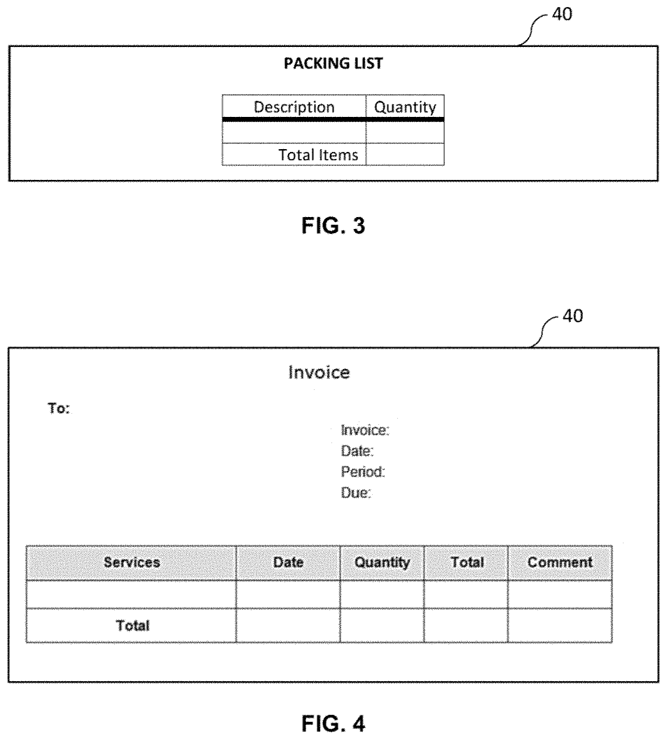

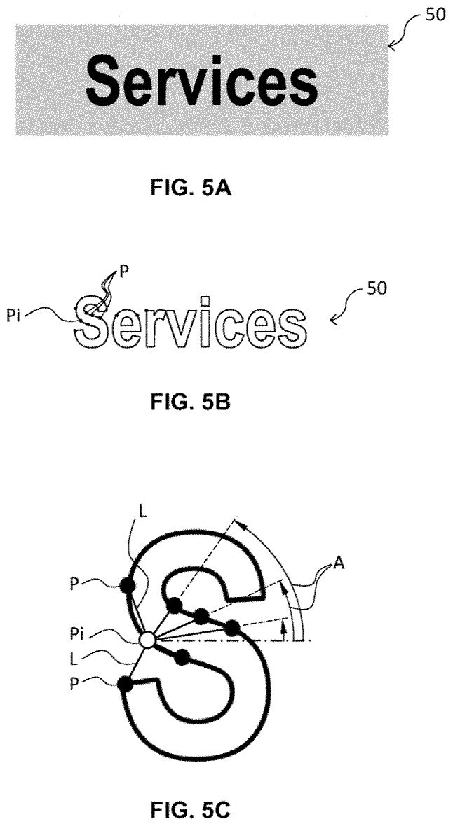

FIG. 3 shows reference image 40 of a blank version of an example document form for which the words “Packing,” “Description,” “Quantity,” and “Total” may be selected to be keywords for that particular document form. FIG. 4 shows reference image 40 of a blank version of another example document form for which the words “Invoice,” “To,” “Service,” and others may be selected to be keywords for that particular document form.

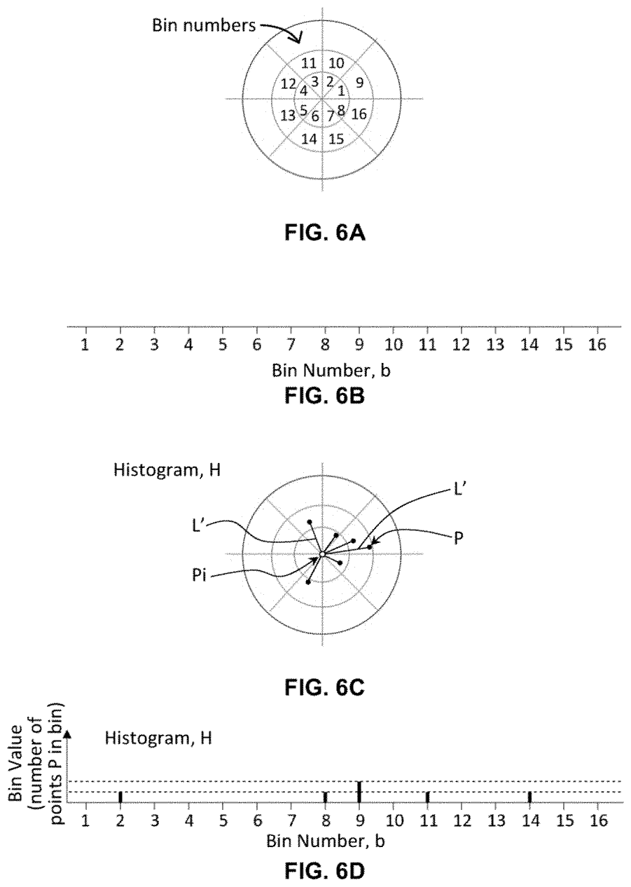

FIG. 5A shows an enlarged view of word “Service” from reference image 40 of FIG. 4. The word was selected to be one of the keywords for the document form of FIG. 4. One or more histograms are obtained for each keyword. A plurality of points are on each keyword. For example, the points are located on a boundary of connected pixels that define the keyword. In FIG. 5A, connected black pixels form the letter S, and the boundary of the connected black pixels is defined by a change in pixel value from black to grey. In FIG. 5B, the boundary is illustrated as a black line for clarity, and a few points P on the boundary are indicated by black dots for clarity. The total number of points P may be less than what is illustrated, or may be greater than what is illustrated. For example, the total number of points P may be greater than 100 for each keyword. Each histogram corresponds to a respective point among the plurality of points. The respective point of each histogram differs from those of the other histograms. Each histogram represents a distribution of other points relative to the respective point of the histogram.

FIG. 5C shows a further enlarged view of the letter S to demonstrate how a histogram is obtained for a respective point Pi among the various points P of the keyword. Respective point Pi is illustrated as a white or hollow dot to distinguish it from other points P. The histogram for point Pi represents a distribution of other points P relative point Pi. For example, the histogram for point Pi represents a distribution of other points P relative point Pi, which points P are exclusively on the same connected component (the letter S defined by connected (i.e., touching) black pixels). The distribution of points P relative to Pi is represented by a set of the various straight-line distances L and angular orientations of the straight-line distances. For example, the dash-dot horizontal line in FIG. 5C may represent a zero degree orientation from which angles A are measured for each of the various straight-line distances L. The dash-dot line represents a reference coordinate that may be computed specifically for the connected component (e.g., the letter S in FIG. 5C). One or more characteristics of the connected component, such as the centroid or other characteristic may be used to determine the reference coordinate. Thus, the orientation of the reference coordinate (e.g., the dash-dot line in FIG. 5C) may depend on the size and shape of the connected component. Distances L and angles A may represent coordinates in a polar coordinate system. Thus, the histogram for point Pi may represent a polar distribution of the other points P located on the input image. The total number of points may be limited to enhance computing efficiency. For example, the histogram for point Pi may represent a polar distribution of the other points P located exclusively on the same connected component (e.g., the letter S) as Pi. In another example, the histogram for point Pi may represent a polar distribution of the other points P located exclusively within a defined local region around Pi.

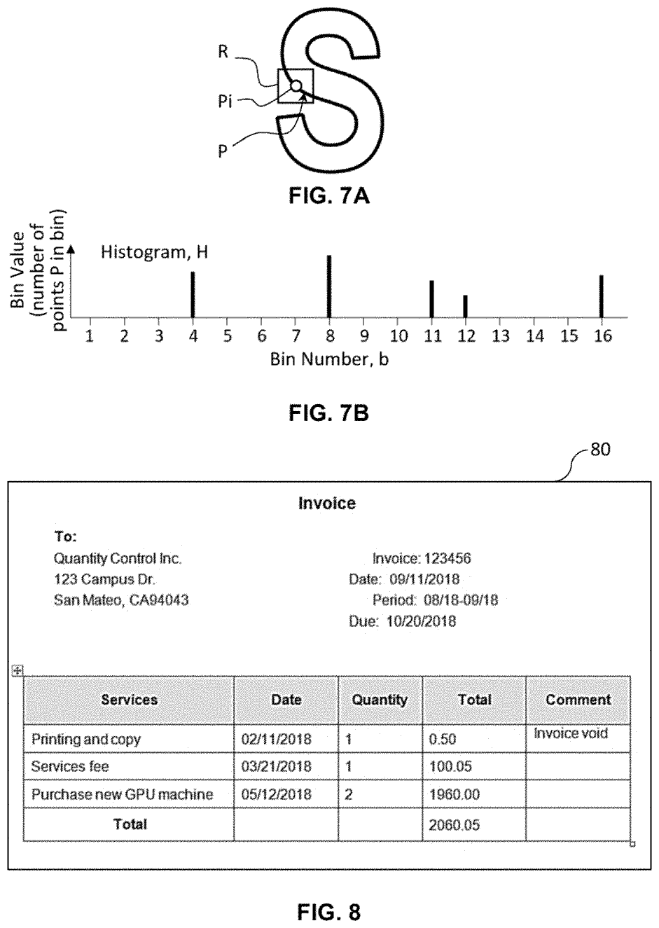

FIG. 6A shows a polar coordinate system for a histogram. The area of the polar coordinate system can be divided into sectors or bins b=1 through 16. In FIG. 6A, sixteen bins b are labeled. The area can be divided into a lesser or greater number of bins than what is illustrated.

FIG. 6B shows an axial representation of the bins of FIG. 6A.

FIG. 6C shows a histogram of point Pi in FIG. 5C. The histogram represents the polar distribution of the other points P in FIG. 5C. As illustrated, distances L′ are scaled linearly from distances L in FIG. 5C. Each of bins b=2, 8, 11, and 14 contains one point. Bin b=9 contains two points. Alternatively, the distances L may be scaled in other ways such that more emphasis is placed on points P that are closer or further away from point Pi. For example, the distances L in FIG. 5C may be scaled logarithmically to obtain distances L′. That is, distances L′ in FIG. 6C would instead be the logarithm of distances L from FIG. 5C.

FIG. 6D shows an axial representation of the histogram of FIG. 6C. As in FIG. 6C, each of bin b=2, 8, 11, and 14 contains one point, and bin b=9 contains two points. In other words, bins 2, 8, 11, and 14 have bin values of one. Bin 9 has a bin value of two. Each of the remaining bins has a bin value of zero.

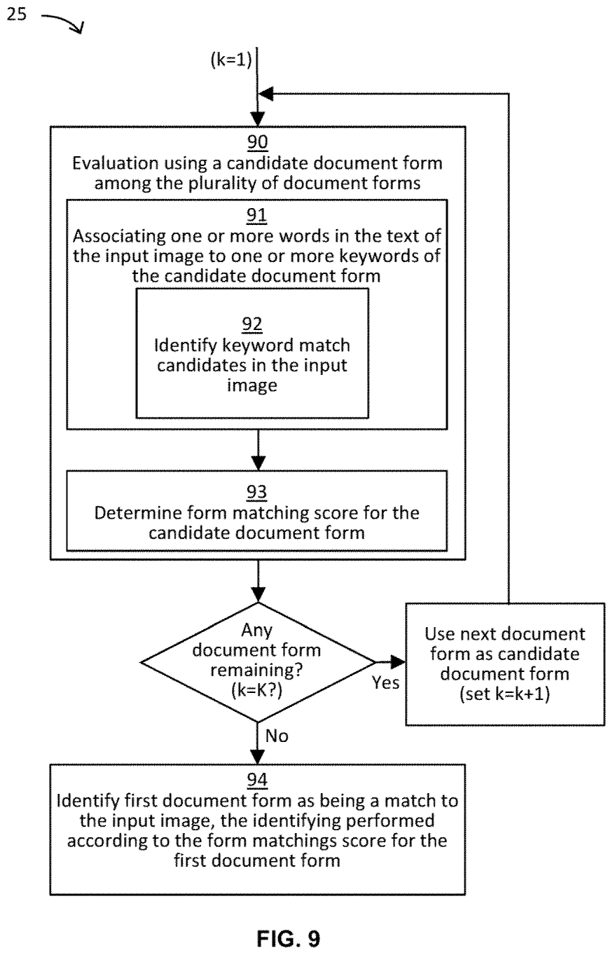

FIG. 7A shows a defined local region R around point Pi. As mentioned above, the histogram for point Pi may represent a polar distribution of points P within defined local region R around Pi. Although not illustrated individually, points P may be spaced closely together. For example, points P may be adjacent pixels on the boundary. There may greater than 20, 40, or 50 points P within defined local region R.

FIG. 7B shows an example histogram representing the polar distribution of the points P within defined local region R wherein distances L have been scaled logarithmically.

Referring again to FIG. 2, during analysis 21, keywords are selected for the document form that was subjected to scanning 20. Each keyword as a set of points Pi, and a histogram is computed for each point Pi of the keyword. This process is performed for all keywords as they appear on reference image 40. During cataloging 22, database 23 stores the keywords in association with the scanned document form, and stores the computed histograms in association with respective keywords. Scanning 20, analysis 21, and cataloging 22 may be performed for any number of blank document forms, such that database 23 may store keywords and histograms in association with a plurality of document forms. For example, scanning 20, analysis 21, and cataloging 22 may be performed on reference images 40 of the blank document forms of FIGS. 3 and 4. The keywords and associated histograms are used for document form identification. That is, the keywords and associated histograms are used to match an input image to one of the document forms that have been cataloged in database 23.

Still referring to FIG. 2, image processing includes scanning 24 a filled-in document form to generate an input image, which is an electronic image of the filled-in document form. The input image is subjected to analysis 25, which includes performing a plurality of evaluations on the input image. The evaluations are performed to match the input image to a document form that is identified out of a plurality of document forms, which were previously cataloged in database 23. Each one of the evaluations is performed using a candidate form among the plurality of document forms. The candidate form for each evaluation differs from those of the other evaluations. For example, the input image may be evaluated against a candidate form corresponding to FIG. 3, and then evaluated against a candidate form corresponding to FIG. 4. Thus, the plurality of evaluations includes a first evaluation in which the candidate form corresponds to FIG. 3 and a second evaluation in which the candidate form corresponds to FIG. 4. One of the candidate forms is identified, out of the plurality of document forms, as being a match to the input image. Thereafter, the input image may be categorized 26 according to the identified candidate form. Categorizing 26 may comprise storing the input image in association with the identified candidate form. This can allow input images of various filled-in document forms to be categorized to facilitate a search operation. For example, the input images may be categorized as either an invoice or a packing list, so all invoices may be identified by a search operation. Additionally or alternatively, data is extracted 27 from the input image and stored 28 in association with the keywords of the identified candidate form.

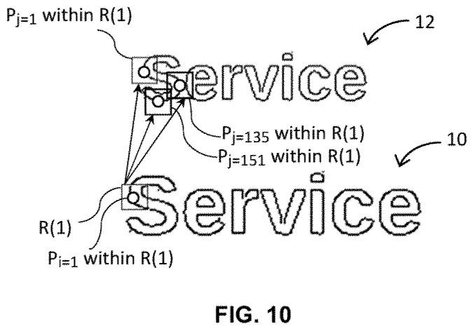

FIG. 8 shows input image 80 for an example filled-in document. Analysis 25 (FIG. 2) of input image 80 may result in the document form corresponding to FIG. 4 to be identified as being a match to input image 80. Thereafter, data is extracted 27. Referring to one row in FIG. 8, the extracted data may include “printing and copying,” “02/11/2018,” “1,” and “0.50.” These data may be stored 28 in association with keywords of the form corresponding to FIG. 4. For example, the phrase “printing and copying” may be stored in association with keyword “Services,” the numerals “02/11/2018” may be stored in association with keyword “Date,” the number “1” may be stored in association with keyword “Quantity,” and the number “0.50” may be stored in association with keyword

“Total.”

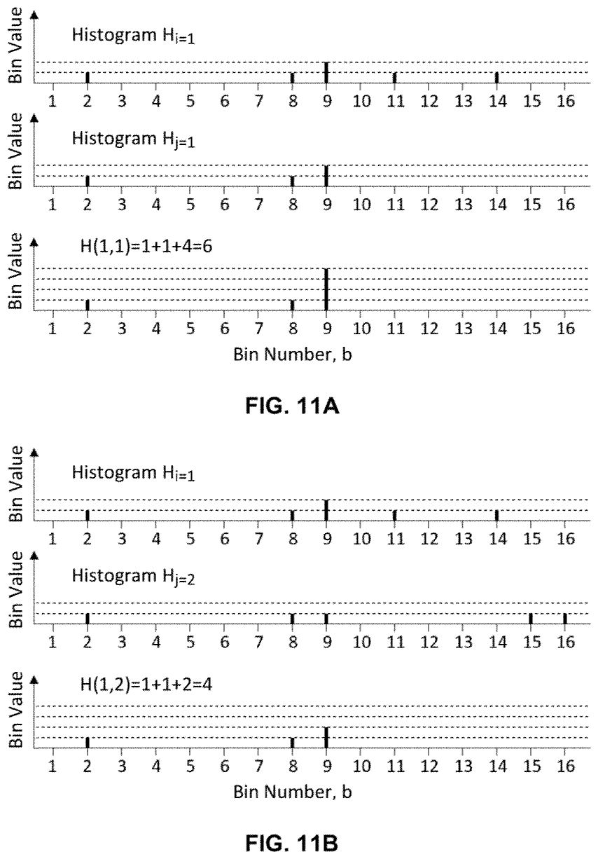

FIG. 9 shows a process for identifying a document form that matches an input image during analysis 25 (FIG. 2). Analysis 25 of an input image includes performing a plurality of evaluations 90 to match the input image to a particular document form. As previously mentioned, each evaluation is performed using a candidate form among the plurality of document forms that have been cataloged in database 23. The capital letter K represents the total number of document forms. Each evaluation comprises associating 91 one or more words in the text of the input image to one or more keywords of the candidate form. Associating 91 is performed to identify 92 keyword matches in the input image. Each evaluation 90 further comprises determining 93 a form matching score for the candidate form. The form matching score is determined from a set of vertices representing locations of keyword matches in the input image. An additional evaluation 90 is performed until every one of the plurality of document forms has been evaluated against the input image.

After the last evaluation, a first document form (one of the candidate forms in the plurality of evaluations) is identified 94 as being a match to the input image. It is to be understood that the term “first document form” is intended to be generic, in that it need not to be the first one evaluated. The identification process is performed according to the form matching score of the first document form. For example, the plurality of document forms may be ranked according to their respective form matching scores that were computed during the evaluations.

As mentioned above, words in the text of the input image are associated 91 with one or more keywords of the candidate form. Associating 91 comprises using histograms of a plurality points on the text of the input image in order to identify 92 keyword matches in the input image. Input image 80 of the filled-in document form includes text, such as “Invoice” at the top and “Services” in the table header of FIG. 8. There is a plurality of points on the text in the input image, in the same manner described previously for points on the keywords in reference image 40 of a candidate form. Each histogram corresponds to a respective point Pi among the plurality of points on the text in input image 80, in the same manner described previously for points on the keywords in a document form. All the descriptions provided above for histograms derived from reference image 40 are the same for the histograms derived from input image 80.

During associating 91 (FIG. 9), the process attempts to find one or more words in the input image that match keywords of the candidate form. The process takes the first keyword (Keyword A) and compares it against the first word (Target Word A) in the input image to see if the two words match. Next, the process compares the Keyword A against a second word (Target Word B) in the input image to see if the two words match. Each comparison involves a word pair: a keyword in an electronic image of the candidate form and a target word in the input image.

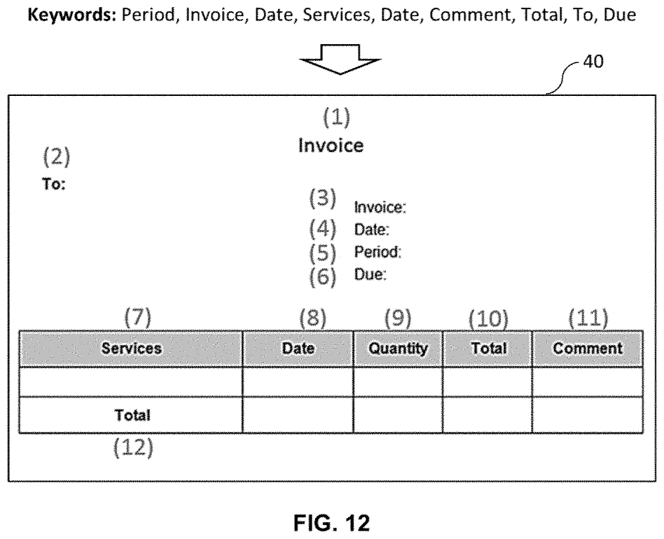

FIG. 10 shows example word pair comprising keyword 10 (“Services”) in reference image 40 of a candidate form and target word 12 (“Services”) in input image 80 of a filled-in document form. Keyword 10 is a cropped portion of reference image 40, and target word 12 is a cropped portion of input image 80. Both words 10 and 12 are illustrated in a realistic manner in which boundaries of the text are jagged due to limited resolution when scanning 20 and 24 (FIG. 2). Prior to scanning, the source documents (the blank and filled-in document forms) may be printed using different settings or printing machines. In addition, scanning 20 and 24 may be performed at different times, and they may be performed using different settings or scanning machines. Thus, there is a possibility for scale variation between the electronic images of the blank and filled-in document forms. To address this possibility, target word 12 is normalized to the same height as the keyword 10. In addition, the width of target word 12 is normalized based on the ratio of heights between the electronic images of the blank and filled-in document forms. After such normalization, for a given point Pi on keyword 10, its approximate location on the input image may be found more easily.

Referring to FIG. 10, keyword 10 has points Pi, where i=1 to Np. The term R(i) is the local region of a particular point Pi. Target word 12 has points Pj, where j=1 to M. The process determines whether the word pair is a match during evaluation 90 (FIG. 9) of the candidate form. Evaluation 90 (FIG. 9) of any candidate form may include one or more word pairs. If, for example, an input image has four words and the candidate form has three keywords, then there would be 4×3=12 word pairs. For each word pair, word matching score W is computed from the following two equations.

$$\begin{matrix}W = \frac{1}{\vert Np \vert} {\sum }_{i ∈ P} {max }_{j ∈ R ( i )} H ( i , j ) & Eqn . 1 \\ H ( i , j ) = {\sum }_{b = 1}^{B} {H}_{i} ( b ) {H}_{j} ( b ) & Eqn . 2\end{matrix}$$

In Eqn. 1, Np represents the total number of points Pi in keyword 10. In Eqn. 2, B represents the total number of bins in histograms Hi and Hj. In the keyword, each point Pi has a histogram Hi. Histogram Hi represents the distribution of other points within local region R(i) centered on Pi. In target word 12, each point Pj has a histogram Hj. Histogram Hj represents the distribution of other points within local region R(i) centered on Pj. Referring to FIG. 10, R(1) is the local region defined for point P₁ in keyword 10. Database 23 (FIG. 2) already contains histogram H₁ associated with P₁ and R(1). During analysis 25 (FIG. 2), specifically during associating 91 (FIG. 9), the same local region R(1) is used to obtain histograms for points in target word 12, such as points P₁, P₁₃₅ and P₁₅₁ illustrated in FIG. 10. Use of the local region and reference coordinate can compensate for variations in scale and rotation between keyword 10 and target word 12.

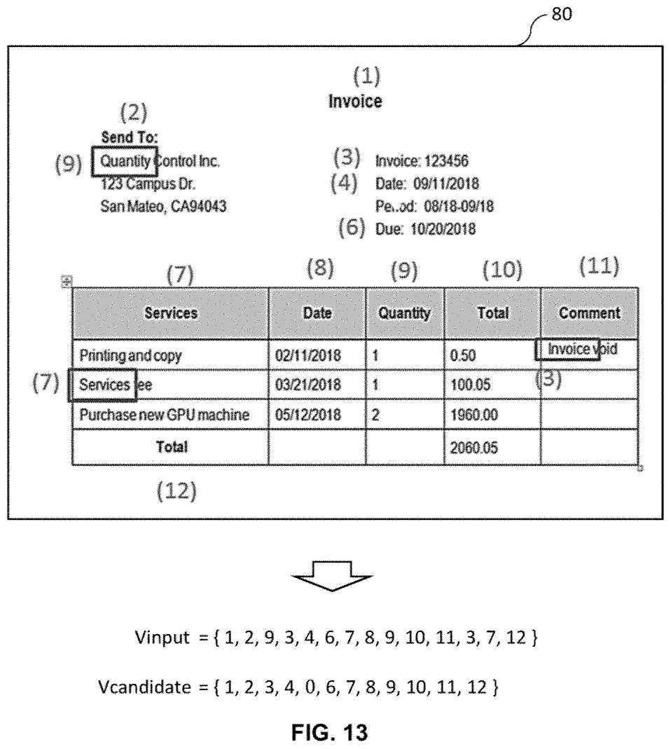

In Eqn. 2, tally number H(i, j) is a sum of bin values, where each bin value is a product of corresponding bin values in Hi and Hj. FIG. 11A shows examples for Hᵢ₌₁ and Hⱼ₌₁, and the result for H(1, 1). Bin 2 has a bin value of 1 in Hᵢ₌₁ and Hⱼ₌₁, which yields 1×1=1. Bin 8 has a bin value of 1 in Hᵢ₌₁ and Hⱼ₌₁, which yields 1×1=1. Bin 9 has a bin value of 2 in Hᵢ₌₁ and Hⱼ₌₁, which yields 2×2=4. The sum of all the bin values from bin b=1 to 16 results in tally number H(1,1)=1+1+4=6.

FIG. 11B shows examples for Hᵢ₌₁ and Hⱼ₌₂, and the result for H(1, 2). Bin 2 has a bin value of 1 in Hᵢ₌₁ and Hⱼ₌₂, which yields 1×1=1. Bin 8 has a bin value of 1 in hᵢ₌₁ and Hⱼ₌₂, which yields 1×1=1. Bin 9 has a bin value of 2 in Hᵢ₌₁ and a bin value of 1 in Hⱼ₌₂, which yields 2×1=2. The sum of all the bin values from bin b=1 to 16 results in H(1,2)=1+1+2=4.

When i=1 in Eqn. 1, the process computes max H(1, j) among all regions j=1 to M of target word 12. The max function returns the maximum tally number, which represents a particular point Pj in the target word that is the best match candidate for the first point P1 of keyword 10. When i=2, the process computes max H(2, j) among all regions j=1 to M of the same target word. The max function returns the maximum tally number, which represents a particular point Pj in the target word that is the best match candidate for the second point P2 of the keyword. This is repeated to compute max H(3, j), H(4, j), and so on until i=N, i.e., until a best match candidate is found for every point Pi of the keyword. The process then computes the sum of all max values, as shown in Eqn. 1. To compute the word matching score W for the word pair, the process normalizes the sum by dividing the sum by the total number of points Np for that keyword.

A word matching score W is computed for all word pairs, i.e., for all pairs of target words in the input image and keywords in the candidate form. Thus, a plurality of word matching scores W are computed when an input image is evaluated against a particular candidate form.

TABLE I shows an example in which word matching scores W are computed for the first four target words (A to D) of an input image and the first three keywords (A to C) of a document form. It is to be understood that an input image may have more than three target words, and a document form may have more than four keywords.

TABLE I

| | Target | Target | Target | Target |
|---|---|---|---|---|
| | Word A | Word B | Word C | Word D |
| Keyword A | W_{AA} ₍match) | W_{AB} | W_{AC} | W_{AD} |
| Keyword B | W_{BA} | W_{BB} | W_{BC} | W_{BD} |
| Keyword C | W_{CA} | W_{CB} ₍match) | W_{CC} | W_{CD} |

To determine whether a word pair is a match, the word matching score W of the word pair is evaluated against a word match requirement. For example, the word match requirement may be a threshold value, Tw. If W≥Tw, then the word pair is match. If W<Tw, then the word pair is not a match. In the example of TABLE I, the word “match” indicates W≥Tw. Target Word A is associated Keyword A. Target Word A matches Keyword A, so Target Word A is referred to as a keyword match. Target Word B is associated with Keyword C. Target Word B matches Keyword C, so Target Word B is referred to as a keyword match.

As shown in TABLE I, the process determines a first word matching score (e.g., W_{AA}) for a first word (e.g., Target Word A) in the text of the input image. The first word matching score is determined from at least the histogram of a point on the first word and a histogram of a specific point on a specific keyword (e.g., Keyword A) among the keywords of the candidate form. The process determines a second word matching score (e.g., W_{AB}) for a second word (e.g., Target Word B) in the text of the input image. The second word matching score is determined from at least the histogram of a point on the second word and the histogram of the specific point on the specific keyword (Keyword A). The process classifies, according to at least the first word matching score (W_{AA}), that the first word (Target Word A) is a keyword match for the specific keyword (Keyword A). The process classifies, according to at least the second word matching score (W_{AB}), that the second word (Target Word B) is not a keyword match for the specific keyword (Keyword A).

Next, a topological structure of the input image and the candidate form are represented by vectors, Vinput and Vcandidate. The respective vectors comprise vertices that represent the location of target words in the input image and keywords of the candidate form. To get Vcandidate, keywords from the reference image of the candidate form are labeled with a numerical number. The order in which the keywords are numbered is based on the position of the keyword and a reading rule. For example, the reading rule may be “top to bottom, left to right.” An alternative reading rule might be “top to bottom, right to left.”

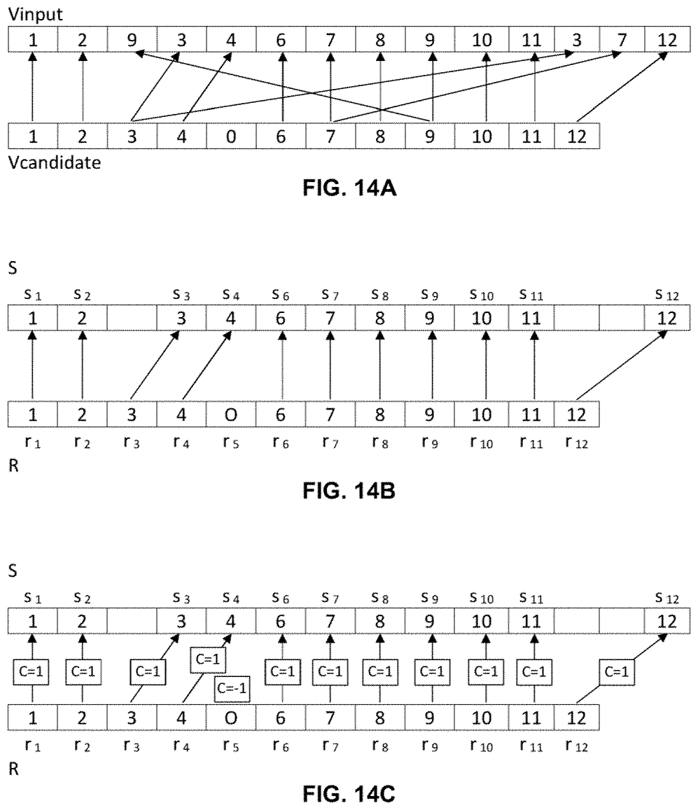

FIG. 12 shows numerical labeling of keywords for the candidate form of FIG. 4. In analysis 21 (FIG. 10), various keywords are selected to be the words “Period,” “Invoice,” “Date,” and so on. The selected keywords, listed at the top of FIG. 12, do not necessarily appear in that order in the document form. In addition, the same keyword may be present in more than one location. Using a “top to bottom, left to right” reading rule, the locations of keywords are labeled sequentially with a numerical location label (illustrated in parenthesis). It is to be understood that the numerical location labels in parenthesis are not actually part of reference image 40. The numerical location labels are illustrated for purposes of discussion. Keyword “Period” is at one location labeled (5), keyword “Invoice” is at two locations labeled (1) and (3), keyword “Date” is at two locations labeled (4) and (8), and so on. In the example of FIG. 12, the topological structure of the candidate document is represented by numerical location labels 1, 2, 3, 4, 5, 6, 7, 8, 9, 10, 11 and 12 associated with the keywords. The labels and associated keywords may be stored in database 23 (FIG. 2) according to TABLE II.

TABLE II
Sequential order of Keywords defined for Candidate
Form Numerical Location Label in ( )

| | |
|---|---|
| Invoice | (1) |
| To | (2) |
| Invoice | (3) |
| Date | (4) |
| Period | (5) |
| Due | (6) |
| Services | (7) |
| Date | (8) |
| Quantity | (9) |
| Total | (10) |
| Comment | (11) |
| Total | (12) |

TABLE III
Sequential order of Keywords Matches found in Input Image

| | |
|---|---|
| Invoice | (1) |
| To | (2) |
| Quantity | (9) |
| Invoice | (3) |
| Date | (4) |
| Due | (6) |
| Services | (7) |
| Date | (8) |
| Quantity | (9) |
| Total | (10) |
| Comment | (11) |
| Invoice | (3) |
| Services | (7) |
| Total | (12) |

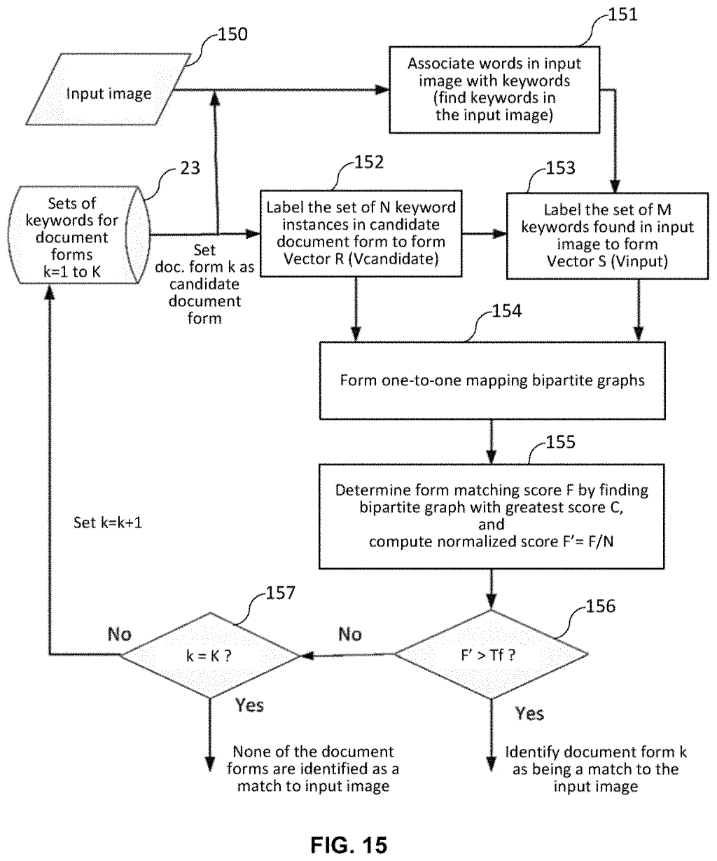

FIG. 13 shows reference image 80 of the filled-in document form of FIG. 8 with target words that have been identified as keyword matches. In analysis 25 (FIG. 2), histograms are used as previously described to identify keyword matches in the input image based on word matching scores W. After all word pairs (see, e.g., TABLE III) have been evaluated to identify all keyword matches, the process uses the same reading rule (“top to bottom, left to right”) that was used for establishing numerical location labels 1 through 12 in TABLE II. TABLE III shows the sequential order of keyword matches that were found in the input image of FIG. 13. The keyword matches are listed with corresponding numerical location labels taken from TABLE II. FIG. 13 shows the corresponding numerical location labels for purposes of discussion. It is to be understood that the numerical location labels in parenthesis are not actually part of input image 80.

In TABLE III, there are two instances of keyword “Quantity” because “Quantity Control Inc.” was entered in the filled-in document form. A rectangle is illustrated in FIG. 13 to highlight this fact. Similarly, there are extra instances of keywords “Invoice” and

“Services” due to entries in the filled-in-document form. Also note that keyword “Period” was not found in the input image of FIG. 13. This may be due to a smudge or stray mark on the filled-in document form, or due to a scanning error, or due to some other cause.

The elements or vertices of Vinput are based on locations of keyword matches in the input image. Vinput is an example of an input image vector that defines a set of keyword match vertices that represent locations of keyword matches in the input image. For the example of FIG. 13, the vertices of Vinput are the numerical location labels taken from Table III. Thus,

Vinput={1, 2, 9, 3, 4, 6, 7, 8, 9, 10, 11, 3, 7, 12}

The elements or vertices of Vcandidate are based on whether the keyword of the candidate form matched any target word in the input image. If a match was found, the location label of that keyword serves as a vertex in Vcandidate. If the keyword is not found, a not-found flag (e.g., 0) serves as an element in Vcandidate. Vcandidate is an example of a document form vector that defines a set of keywords vertices that represent locations of keywords of the candidate form. For the example of FIG. 13, the vertices of Vcandidate are the numerical location labels taken from Table II, except a not-found flag (e.g., 0) is the vertex value for keyword “Period” since it had no match in the input image. Thus,

Vcandidate={1, 2, 3, 4, 0, 6, 7, 8, 9, 10, 11, 12}

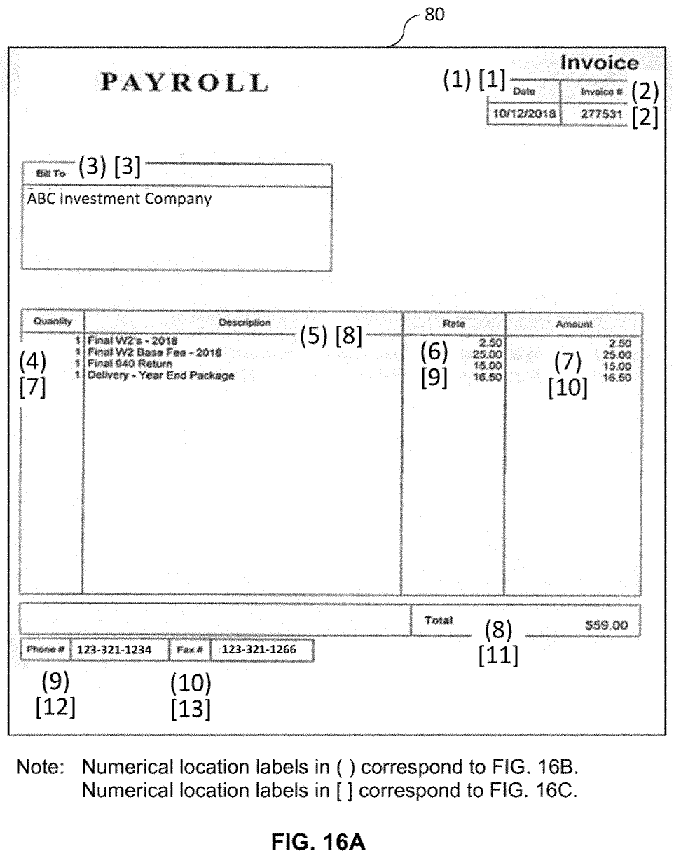

In FIG. 14A, Vinput and Vcandidate are two disjoint and independent sets of vertices of a bipartite graph. Differing from a general bipartite graph, there are “edges” formed by lines that connect vertices that match. That is, an edge connects a keyword vertex in Vcandidate to a keyword match vertex having the same location label. There is no edge for a keyword vertex (e.g., keyword “Period”) that has no corresponding keyword match vertex. Edges that cross other edges are referred to as cross-edges. Cross-edges are present when a keyword vertex (e.g., keyword “Quantity”) has more than one corresponding keyword match vertex.

In FIG. 14B, cross-edges are deleted. When cross-edges are deleted, the two disjoint sets Vinput and Vcandidate form a one-to-one mapping bipartite graph. With this one-to-one property (one vertex to one vertex), the encoding scheme preserves the keywords in the same topological relationship between the electronic image of the blank document form and input image if the two images contain the same type of document form.

In FIG. 14B, keyword match vertices in Vinput have been deleted so that repeat matches are eliminated. Vinput and Vcandidate are renamed as vectors S and R, respectively. The vertices of S are represented by lower case letters, as in {S₁. . . S_{M}} with a total of M vertices. The vertices of R are presented by {r₁. . . r_{N}}, with a total of N vertices. It is possible that a keyword (e.g., “Period”) is not found in the input image; therefore, N≥M. With this notation, a form matching score F is computed according to the following equations.

$$\begin{matrix}F = {max}_{d ∈ D ⋐ S} {\sum }_{i = 1}^{N} C ( {r}_{i} , {s}_{i} ) & Eqn . 3 \\ C ( {r}_{i} , {s}_{i} ) := \{ \begin{matrix}1 & if {r}_{i} = {s}_{i} \\ - 1 & if {r}_{i} = O\end{matrix} & Eqn . 4\end{matrix}$$

In Eqn. 3, D represents the subsets of S with one or more keyword match vertices deleted as shown in FIG. 14B to provide a one-to-one mapping bipartite graph. Cost function C returns 1 if the keyword vertex in R has a corresponding keyword match vertex in S. Thus, cost function C provides a numerical count of keyword vertices in R that have a corresponding keyword match vertex in S. Form matching score F is determined at least from this numerical count. In addition, cost function C returns −1 if the keyword vertex in R contains a not-found flag (e.g., O). In other words, cost function C returns −1 if the keyword vertex in R has no corresponding keyword match vertex in S.

FIG. 14C shows values of C for vertices 1 to N. The sum of C values is 11−1=10. There can be more than one way to delete cross-edges, thereby allowing for multiple subsets of S in Eqn. 3. FIG. 14C shows one bipartite graph for one particular subset of S. A bipartite graph would be formed and analyzed for each subset of S. The sum of C values may differ among multiple subsets of S. Accordingly, form matching score F is determined by finding the maximum among the sum of C values. In the example of FIG. 14A, we assume the subset of S shown in FIG. 14B provides the maximum sum of C values. Thus, in this example, form matching score F=10.

Form matching score F is determined for each candidate form under evaluation 90 (FIG. 9). In each evaluation 90, the candidate form is taken from among a plurality of document forms from k=1 to K. The process identifies the candidate form that best matches the input image according to the following equations.

$$\begin{matrix}k = arg {max}_{k ∈ \{ 1 … K \}} \{ {F}_{k}^{′} \} & Eqn . 5 \\ {F}_{k}^{′} = {F}_{k} \text{/} {N}_{k} & Eqn . 6\end{matrix}$$

The total number of keywords N may vary among the candidate forms, so the form matching score F of candidate form k is normalized by dividing it by N. The normalized form matching score is F′=F/N. The candidate form k with the greatest normalized form matching score F′ is identified as being a match to the input image. From the foregoing, it should be understood that such identification was performed according to the form matching score F for that particular candidate form. For example, if candidate form k=1 corresponds to the document form of FIG. 3 and candidate form k=2 corresponds to the document form of FIG. 4, the process will determine form k=2 as having a greater form matching score than form k=1. As a result, the process will identify form k=2 as being a match to the input image of FIG. 8.

In the event that two or more candidate forms have same and the greatest normalized form matching scores F′ among a total of K document forms, then candidate form k′ with the greatest number of keywords N is identified as being a match to the input image. This is because the candidate form with the greatest number of keywords is the most likely match. Candidate form k′ may be found according to the following equation.

$${k}^{′} = arg {max}_{k ∈ K} \vert {N}_{k} \vert \qquad Eqn . 7$$

For example, one of the evaluations 93 (FIG. 9) may determine that a first document form has form matching score F₁ or F′₁. Another one of the evaluations 93 (FIG. 9) may determine that a second document form has form matching score F₂ or F′₂. which is equal to that of the first document form. If all other document forms have lesser form matching scores, the total number of keywords are examined. In this example, the reference image for the first document form has a total of N1 keywords, and the reference image for the second document form has N2, which is less than N1. According to Eqn. 7, the first document form would be identified as being the match to the input image according to N1 being greater than N2.

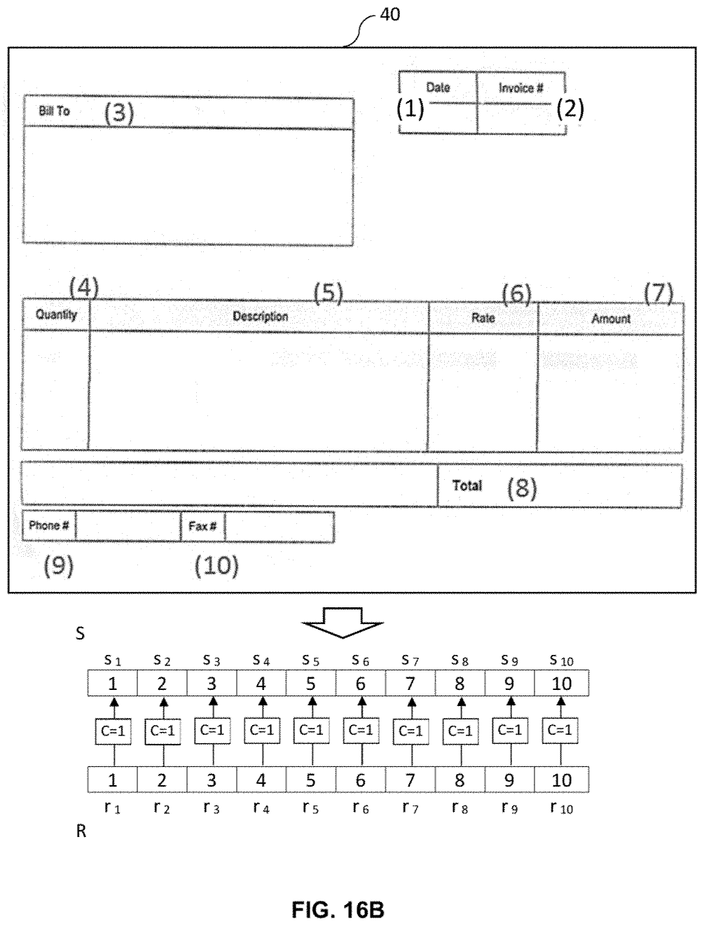

FIG. 15 shows an example flow diagram for identifying a candidate form as being a match to an input image. At block 150, the input image is obtained, such as by scanning 24 (FIG. 2). Database 23 contains sets of keywords for various document forms, there being a total of K document forms. The sets of keywords were stored in database 23 as previously described for processes 20, 21 and 22 (FIG. 2). Starting with the first document form (k=1), the set of keywords for that form is used at block 151, in which the input image is analyzed 25 (FIG. 2). The analysis includes associating 91 (FIG. 9) one or more words in the text of the input image to one or more keywords of the candidate form. At blocks 152 and 154, vectors R and S (also referred to as Vcandidate and Vinput) are defined by applying numerical location labels according to a reading input rule, as previously described for process 92 (FIG. 9) and illustrated in FIGS. 12 and 13. At block 154, one or more bipartite graphs are formed by eliminating repeat keyword match vertices in S as illustrated in FIG. 14B. At block 154, a form matching score F for the candidate form is determined according to Eqn. 3 and Eqn. 4 above. In addition, a normalized form matching score F′ is computed according to Eqn. 6 above. At block 156, normalized form matching score F′ is compared to threshold value Tf. For example, if F′>Tf, then the candidate form is identified as being a match to the input image, and no further document forms are evaluated. If F′<Tf, the process determines at block 157 whether there are any more document forms to be evaluated (i.e., whether k=K). If k=K, then it is determined that none of the document forms match the input image. If k≠K, then k is incremented (k=k+1) so that the same input image is evaluated against the next document form.

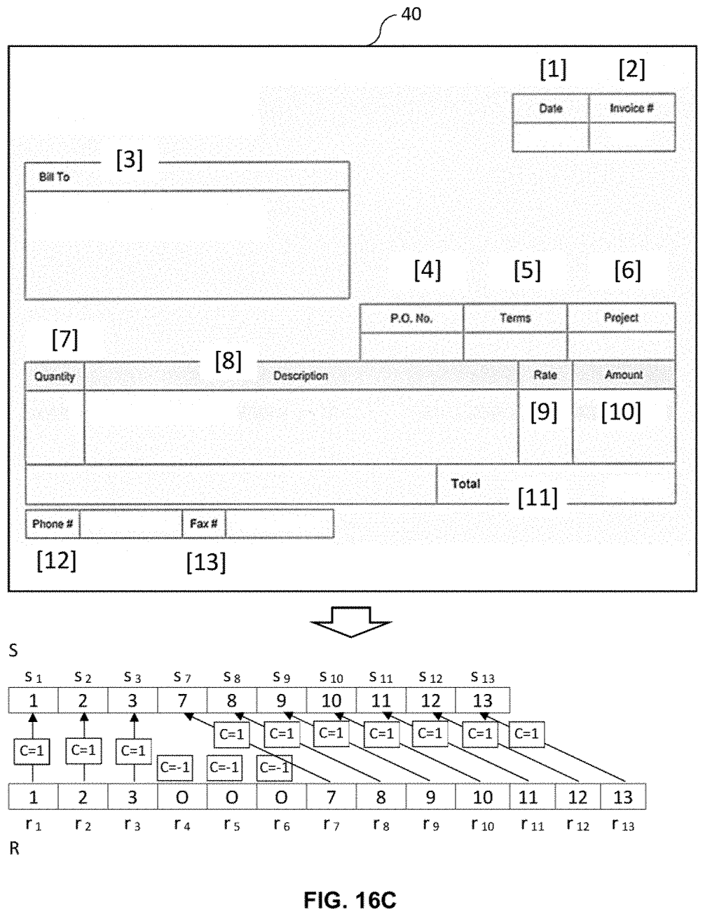

FIG. 16A shows an example input image generated by scanning a filled-in document form. FIGS. 16B and 16C show examples of document forms that are almost identical. The difference is that the document form of FIG. 16C has an additional one-row table with three keywords. In a first evaluation of the input image with the candidate form of FIG. 16B, the process defines vectors S={1, 2, 3, 4, 5, 6, 7, 8, 9, 10} and R={1, 2, 3, 4, 5, 6, 7, 8, 9, 10}. In FIG. 16B, there are N=10 keyword locations in the candidate form. The corresponding bipartite graph is shown in FIG. 16B with values for C determined according to Eqn. 4 above. The sum of C values gives form matching score F=10. Note that the sum of C values is based on a numerical count of keyword vertices in R that have a corresponding keyword match vertex in S. Thus, form matching score F is determined at least from this numerical count. The normalized form matching score is F′=F/N=10/10=1.

In a second evaluation of the input image with the candidate form of FIG. 16C, the process defines vectors S={1, 2, 3, 4, 5, 6, 7, 8, 9, 10} and R={1, 2, 3, 0, 0, 0, 4, 5, 6, 7, 8, 9, 10}. Note that keywords “P.O. No.,” “Terms,” and “Project” were not found in the input image, so they are labeled with a not-found flag (“O”) in vector R. In FIG. 16C, there are N=13 keyword locations in the candidate form. The corresponding bipartite graph is shown in FIG. 16C. The sum of C values gives form matching score F=10−3=7. Note that the sum of C values is based a first number and a second number. The first number, namely 10, is a count of keyword vertices in R that have a corresponding keyword match vertex in S. The second number, namely 3, is a count of keyword vertices in R that do not have a corresponding keyword match vertex in S. Thus, form matching score F is determined from the first and second numbers. The normalized form matching score is F′=F/N=(10−3)/13=0.54.

The process would select the document form of FIG. 16B because it has a greater F or F′ score. In this example, a specific document form (FIG. 16C), from among the plurality of document forms, is classified as not being a match to the input image. The classifying is performed according to the form matching score (either F=7 or F′=0.54) that was determined for the specific document form. It will be appreciated that even though all keywords of the document form of FIG. 16C were found in the input image, the process is still able to determine that the document form of FIG. 16B is the most likely match.

The forgoing descriptions present an approach that utilizes the topological structure of keyword distribution in an input image to determine whether the input image matches a document form that has been previously defined. The use of histograms provides a robust method for finding keyword matches in the input image. With use of histograms, keywords match candidates may be reliably found even with variations in scale and rotation. The use of vectors R and S allows the process to identify the document form that most likely matches the given input image. By using a predefined reading rule to form the vectors, the process is able to discriminate between document forms that have the same keywords but have different keyword layouts. The one-to-one bipartite graph approach allows for reliable form identification even when entries in the input image contain words that might otherwise confuse the process.

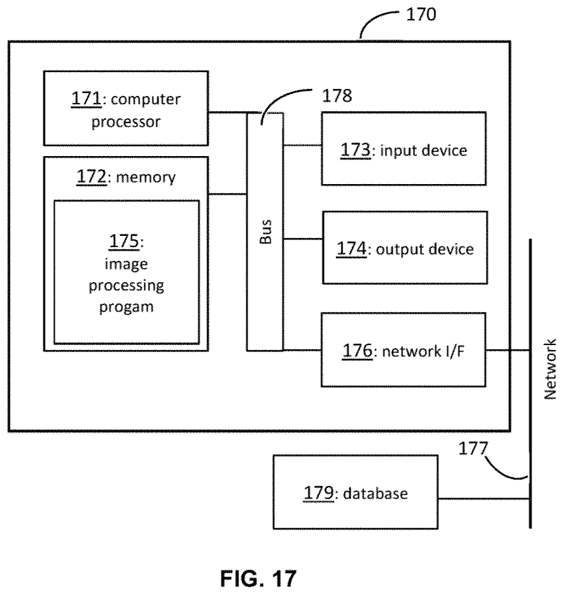

FIG. 17 shows example apparatus 170 configured to perform the methods and processes described herein. Apparatus 170 can be a server, computer workstation, personal computer, laptop computer, tablet, smartphone, facsimile machine, printing machine, multi-functional peripheral (MFP) device that has the functions of a printer and scanner combined, or other type of machine that includes one or more computer processors and memory.

Apparatus 170 includes one or more computer processors 171 (CPUs), one or more computer memory devices 172, one or more input devices 173, and one or more output devices 174. The one or more computer processors 171 are collectively referred to as processor 171. Processor 171 is configured to execute instructions. Processor 171 may include integrated circuits that execute the instructions. The instructions may embody one or more software modules for performing the processes described herein. The one of more software modules are collectively referred to as image processing program 175.

The one or more computer memory devices 172 are collectively referred to as memory 172. Memory 172 includes any one or a combination of random-access memory (RAM) modules, read-only memory (ROM) modules, and other electronic devices. Memory 172 may include mass storage device such as optical drives, magnetic drives, solid-state flash drives, and other data storage devices. Memory 172 includes a non-transitory computer readable medium that stores image processing program 175. Database 23 (FIGS. 2 and 15) may form part of memory device 172.

The one or more input devices 173 are collectively referred to as input device 173. Input device 173 may include an optical scanner having a camera and light source and which is configured to scan a document page to generate reference image 40 and/or input image 80. Input device 173 can allow a person (user) to enter data and interact with apparatus 170. Input device 173 may include any one or more of a keyboard with buttons, touch-sensitive screen, mouse, electronic pen, and other types of devices that can allow the user to select keywords during analysis 21 (FIG. 2).

The one or more output devices 174 are collectively referred to as output device 174. Output device 174 may include a liquid crystal display, projector, or other type of visual display device. Output device 174 may be used to display reference image 40 and/or input image 80. Output device 174 may include a printer that prints a copy of reference image 40 and/or input image 80.

Apparatus 170 includes network interface (I/F) 176 configured to allow apparatus 170 to communicate with other machines through network 177, such as a local area network (LAN), a wide area network (WAN), the Internet, and telephone communication carriers. Network I/F 176 may include circuitry enabling analog or digital communication through network 177. For example, network I/F 176 may be configured to receive image 10 from another machine connected to network 177. Network I/F 176 may be configured to transmit an encoded version of image 10 that has been subjected to a character recognition process. The above-described components of apparatus 170 are communicatively coupled to each other through communication bus 178.

Database 23 (FIGS. 2 and 15) may be external to apparatus 170. In which case, network interface (I/F) 176 is configured to communicate with database 23 via network 177. Network interface (I/F) 176 is configured to communicate another database 179 to enable database 179 to store data extracted from the input image in association with the keywords of the document form that was identified as matching the input image. Network interface (I/F) 176 is configured to communicate another database 179 to enable database 179 to store the input image in association with the document form that was identified as matching the input image.

While several particular forms of the invention have been illustrated and described, it will also be apparent that various modifications may be made without departing from the scope of the invention. It is also contemplated that various combinations or subcombinations of the specific features and aspects of the disclosed embodiments may be combined with or substituted for one another in order to form varying modes of the invention. Accordingly, it is not intended that the invention be limited, except as by the appended claims.

1. An image processing method performed by a computer system, the method comprising:
performing a plurality of evaluations on an input image having text, the evaluations performed to match the input image to a document form that is identified out of a plurality of document forms, each one of the evaluations performed using a candidate form among the plurality of document forms, the candidate form for each evaluation differing from those of the other evaluations, each evaluation comprising
associating one or more words in the text of the input image to one or more keywords in a reference image of the candidate form, the associating performed to identify keyword matches in the input image, and
determining a form matching score for the candidate form, the form matching score determined from keyword match vertices representing locations of keyword matches in the input image; and
identifying a first document form as being a match to the input image, the first document form being one of the candidate forms in the plurality of evaluations, the identifying performed according to the form matching score that was determined for the first document form.

2. The image processing method of claim 1, further comprising, after the identifying of the first document form as being the match, storing data extracted from the input image in association with the keywords of the first document form.

3. The image processing method of claim 1, further comprising categorizing the input image according to the first document form.

4. The image processing method of claim 1, wherein for each of the evaluations, the associating comprises using histograms of a plurality points on the text of the input image in order to identify keyword matches in the input image, each histogram corresponds to a respective point among the plurality of points, the respective point of each histogram differs from those of the other histograms, each histogram represents a distribution of other points relative to the respective point of the histogram, and the other points are located on the text of the input image.

5. The image processing method of claim 4, wherein each one of the histograms represents a polar distribution of the other points located on the text of the input image.

6. The image processing method of claim 4, wherein, for each histogram, the respective point and the other points are located on a boundary of connected pixels defining the text of the input image.

7. The image processing method of claim 4, wherein for one of the evaluations, the using of the histograms comprises:
determining a first word matching score for a first word in the text of the input image, the first word matching score determined from at least the histogram of a point on the first word and a histogram of a specific point on a specific keyword among the keywords of the candidate form;
determining a second word matching score for a second word in the text of the input image, the second word matching score determined from at least the histogram of a point on the second word and the histogram of the specific point on the specific keyword;
classifying, according to at least the first word matching score, the first word as a keyword match for the specific keyword; and
classifying, according to at least the second word matching score, the second word as not a keyword match for the specific keyword.

8. The image processing method of claim 1, wherein for each one of the evaluations,
a document form vector defines a set of keywords vertices that represent locations of keywords of the candidate form, and
the form matching score for the candidate form is determined at least from a numerical count of keyword vertices that correspond to any of the keyword match vertices.

9. The image processing method of claim 8, wherein for at least one of the evaluations, the form matching score for the candidate form is determined from at least a first number and a second number, first number the numerical count of keyword vertices that correspond to any of the keyword match vertices, the second number is a numerical count of keyword vertices that do not correspond to any of the keyword match vertices.

10. The image processing method of claim 1, wherein for each one of the evaluations, the form matching score determined for the candidate form is normalized according to a numerical count of keywords in the reference image of the candidate form.

11. The image processing method of claim 1, wherein
one of the evaluations determines that a second document form, from among the plurality of document forms, has a form matching score that is equal to the form matching score of the first document form, and
the identifying of the first document form as being the match to the input image is performed according a numerical count of keywords of the first document form being greater than a numerical count of keywords of the second document form.

12. The image processing method of claim 1, further comprising classifying a specific document form, from among the plurality of document forms, as not being a match to the input image, the classifying performed according to the form matching score that was determined for the specific document form.

13. An image processing system comprising:
a processor; and
a memory in communication with the processor, the memory storing instructions, wherein the processor is configured to perform a process according to the stored instructions, the process comprising:
performing a plurality of evaluations on an input image having text, the evaluations performed to match the input image to a document form that is identified out of a plurality of document forms, each one of the evaluations performed using a candidate form among the plurality of document forms, the candidate form for each evaluation differing from those of the other evaluations, each evaluation comprising
associating one or more words in the text of the input image to one or more keywords in a reference image of the candidate form, the associating performed to identify keyword matches in the input image, and
determining a form matching score for the candidate form, the form matching score determined from keyword match vertices representing locations of keyword matches in the input image; and
identifying a first document form as being a match to the input image, the first document form being one of the candidate forms in the plurality of evaluations, the identifying performed according to the form matching score that was determined for the first document form.

14. The image processing system of claim 13, wherein the process performed by the processor further comprises, after the identifying of the first document form as being the match, causing data extracted from the input image to be stored in association with the keywords of the first document form.

15. The image processing system of claim 13, wherein the process performed by the processor further comprises categorizing the input image according to the first document form.

16. The image processing system of claim 13, wherein for each of the evaluations, the associating comprises using histograms of a plurality points on the text of the input image in order to identify keyword matches in the input image, each histogram corresponds to a respective point among the plurality of points, the respective point of each histogram differs from those of the other histograms, each histogram represents a distribution of other points relative to the respective point of the histogram, and the other points are located on the text of the input image.

17. The image processing system of claim 16, wherein each one of the histograms represents a polar distribution of the other points located on the text of the input image.

18. The image processing system of claim 16, wherein, for each histogram, the respective point and the other points are located on a boundary of connected pixels defining the text of the input image.

19. The image processing system of claim 16, wherein for one of the evaluations, the using of the histograms comprises:
determining a first word matching score for a first word in the text of the input image, the first word matching score determined from at least the histogram of a point on the first word and a histogram of a specific point on a specific keyword among the keywords of the candidate form;
determining a second word matching score for a second word in the text of the input image, the second word matching score determined from at least the histogram of a point on the second word and the histogram of the specific point on the specific keyword;
classifying, according to at least the first word matching score, the first word as a keyword match for the specific keyword; and
classifying, according to at least the second word matching score, the second word as not a keyword match for the specific keyword.

20. The image processing system of claim 13, wherein for each one of the evaluations,
a document form vector defines a set of keywords vertices that represent locations of keywords of the candidate form, and
the form matching score for the candidate form is determined at least from a numerical count of keyword vertices that correspond to any of the keyword match vertices.

21-24. (canceled)
